(19) United States
(12) Patent Application Publication
(10) Pub. No.: US 2016/0365105 A1
(43) Pub. Date: Dec. 15, 2016

(54) Hard Disk Drive Actuator Pivot To Base Tower Clearance Spacer Mechanism

(71) Applicant: HGST Netherlands B.V., Amsterdam (NL)

(72) Inventors: Shinichi Kimura, Fujisawa-shi (JP); Nobuyuki Okunaga, Odawara-shi (JP); Hiroki Kitahori, Fujisawa-shi (JP); Hitoshi Inomata, Fujisawa-shi (JP)

(21) Appl. No.: 14/740,028

(22) Filed: Jun. 15, 2015

(51) Int. Cl. G11B 5/48; F16F 15/08

(52) U.S. Cl. CPC G11B 5/4813; F16F 15/08

(57) ABSTRACT

A hard disk drive actuator pivot-base tower clearance spacer mechanism may be positioned at least in part between an enclosure base tower structure, on which a pivot shaft of a pivot bearing assembly is disposed, and the pivot shaft. The spacer mechanism is positioned to affect the clearance between an actuator of which the pivot bearing assembly is part and the base tower structure, such as to limit unwanted tilting of the actuator relative to the tower. The clearance spacer mechanism may comprise an elastic cap or may comprise a spring mechanism configured to fit over the top of the base tower structure so as to compress the spacer mechanism while positioned between the tower structure and the pivot shaft.

### FIELD OF EMBODIMENTS

Embodiments of the invention may relate generally to hard disk drives and more particularly to a clearance spacer mechanism for an actuator pivot-base tower assembly.

### BACKGROUND

A hard-disk drive (HDD) is a non-volatile storage device that is housed in a protective enclosure and stores digitally encoded data on one or more circular disk having magnetic surfaces. When an HDD is in operation, each magnetic-recording disk is rapidly rotated by a spindle system. Data is read from and written to a magnetic-recording disk using a read-write head that is positioned over a specific location of a disk by an actuator. A read-write head uses a magnetic field to read data from and write data to the surface of a magnetic-recording disk. A write head makes use of the electricity flowing through a coil, which produces a magnetic field. Electrical pulses are sent to the write head, with different patterns of positive and negative currents. The current in the coil of the write head induces a magnetic field across the gap between the head and the magnetic disk, which in turn magnetizes a small area on the recording medium.

HDDs are being manufactured which are hermetically sealed with helium inside. Further, other gases that are lighter than air have been contemplated for use as a replacement for air in sealed HDDs. There are various benefits to sealing and operating an HDD in helium ambient, because the density of helium is one-seventh that of air. For example, operating an HDD in helium reduces the drag force acting on the spinning disk stack and the mechanical power used by the disk spindle motor is substantially reduced. Further, operating in helium reduces the flutter of the disks and the suspension, allowing for disks to be placed closer together and increasing the areal density (a measure of the quantity of information bits that can be stored on a given area of disk surface) by enabling a smaller, narrower data track pitch. The lower shear forces and more efficient thermal conduction of helium also mean the HDD will run cooler and will emit less acoustic noise. The reliability of the HDDs is also increased due to low humidity, less sensitivity to altitude and external pressure variations, and the absence of corrosive gases or contaminants.

However, challenges remain in the manufacturing of helium-filled, sealed HDDs. For example, in a sealed HDD it is not necessarily a best practice to attach the bottom screw of the actuator pivot through the base because of leakage concerns.

Any approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY OF EMBODIMENTS

Embodiments of the invention are generally directed at an actuator pivot-base tower clearance spacer mechanism, a hard disk drive (HDD) comprising such a spacer mechanism, and a method for assembling an HDD actuator pivot assembly in which such a spacer mechanism may be utilized. An HDD clearance spacer mechanism is positioned at least in part between an enclosure base tower structure, on which a pivot shaft of a pivot bearing assembly is disposed, and the pivot shaft. The spacer mechanism is positioned to affect the clearance between an actuator, of which the pivot bearing assembly is part, and the base tower structure. For example, the spacer mechanism may be positioned to reduce the clearance between the actuator and the tower, such as to limit unwanted tilting of the actuator relative to the tower.

According to embodiments, the clearance spacer mechanism may comprise an elastic cap configured to fit over the top of the base tower, and in which the outer diameter of the elastic cap is greater than the inner diameter of the pivot shaft so as to compress the elastic cap while positioned between the tower structure and the pivot shaft.

According to embodiments, the clearance spacer mechanism may comprise spring mechanism configured to fit over the top of the base tower, and in which the outermost portion of the spring is greater than the inner diameter of the pivot shaft so as to compress the outermost portion of the spring while positioned between the tower structure and the pivot shaft.

Embodiments discussed in the Summary of Embodiments section are not meant to suggest, describe, or teach all the embodiments discussed herein. Thus, embodiments of the invention may contain additional or different features than those discussed in this section. Furthermore, no limitation, element, property, feature, advantage, attribute, or the like expressed in this section, which is not expressly recited in a claim, limits the scope of any claim in any way.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is a plan view illustrating a hard disk drive (HDD), according to an embodiment;

FIG. 2A is a cross-sectional side view illustrating a pivot bearing assembly coupled to a base with an attachment device;

FIG. 2B is a cross-sectional side view illustrating a pivot bearing assembly coupled to a base tower;

FIG. 3 is a side view illustrating an actuator assembly and a corresponding cross-sectional side view of a pivot bearing assembly coupled to a base tower;

FIG. 4A is a cross-sectional side view illustrating a pivot bearing assembly coupled to a base tower structure including a clearance spacer mechanism, according to an embodiment;

FIG. 4B is a cross-sectional side view illustrating the pivot bearing assembly of FIG. 4A, along with a corresponding magnified view, according to an embodiment;

FIG. 5 is an exploded perspective view illustrating a pivot bearing-base tower assembly including a clearance spacer mechanism, according to an embodiment;

FIG. 6 is a perspective view of a clearance spacer mechanism, according to an embodiment;

FIG. 7A is a cross-sectional side view illustrating the clearance spacer mechanism of FIG. 6 coupled to a base tower, according to an embodiment;

FIG. 7B is a cross-sectional side view illustrating a pivot bearing assembly coupled to a base tower structure including a clearance spacer mechanism, along with a corresponding magnified view, according to an embodiment; and

FIG. 8 is a flow diagram illustrating a method for assembling a hard disk drive (HDD) actuator pivot assembly, according to an embodiment.

### DETAILED DESCRIPTION

Approaches to an actuator pivot-base tower clearance spacer mechanism are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form in order to avoid unnecessarily obscuring the embodiments of the invention described herein.

### Physical Description Of An Illustrative Operating Context

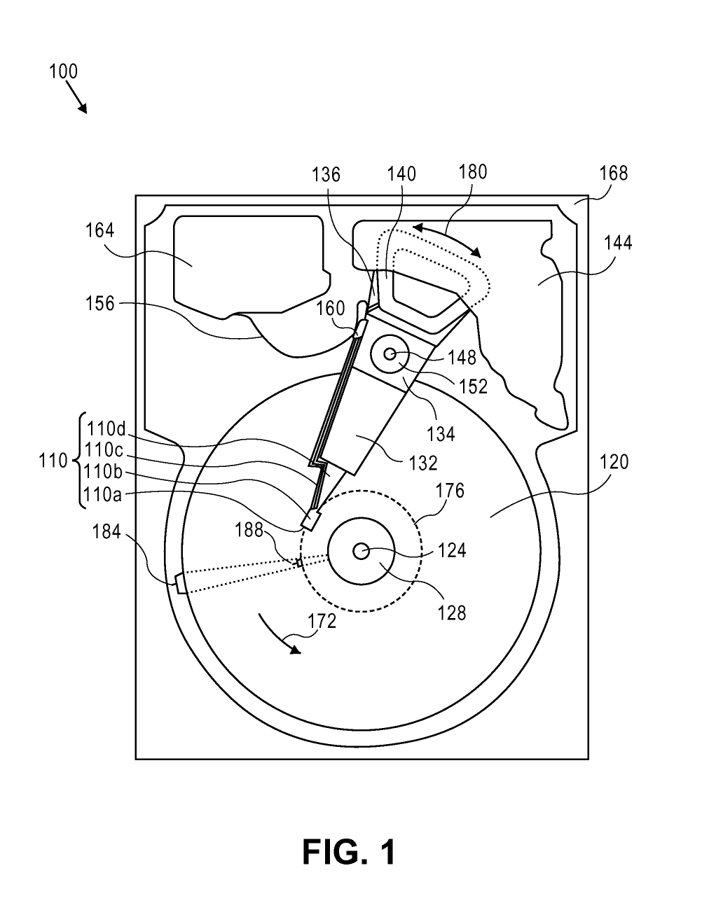

Embodiments may be used in the context of an actuator pivot-base tower assembly for a hard disk drive (HDD). Thus, in accordance with an embodiment, a plan view illustrating an HDD 100 is shown in FIG. 1 to illustrate an exemplary operating context.

FIG. 1 illustrates the functional arrangement of components of the HDD 100 including a slider 110b that includes a magnetic read-write head 110a. Collectively, slider 110b and head 110a may be referred to as a head slider. The HDD 100 includes at least one head gimbal assembly (HGA) 110 including the head slider, a lead suspension 110c attached to the head slider typically via a flexure, and a load beam 110d attached to the lead suspension 110c. The HDD 100 also includes at least one magnetic-recording medium 120 rotatably mounted on a spindle 124 and a drive motor (not visible) attached to the spindle 124 for rotating the medium 120. The read-write head 110a, which may also be referred to as a transducer, includes a write element and a read element for respectively writing and reading information stored on the medium 120 of the HDD 100. The medium 120 or a plurality of disk media may be affixed to the spindle 124 with a disk clamp 128.

The HDD 100 further includes an arm 132 attached to the HGA 110, a carriage 134, a voice-coil motor (VCM) that includes an armature 136 including a voice coil 140 attached to the carriage 134 and a stator 144 including a voice-coil magnet (not visible). The armature 136 of the VCM is attached to the carriage 134 and is configured to move the arm 132 and the HGA 110, to access portions of the medium 120, being mounted on a pivot-shaft 148 with an interposed pivot bearing assembly 152. In the case of an HDD having multiple disks, the carriage 134 is called an “E-block,” or comb, because the carriage is arranged to carry a ganged array of arms that gives it the appearance of a comb.

An assembly comprising a head gimbal assembly (e.g., HGA 110) including a flexure to which the head slider is coupled, an actuator arm (e.g., arm 132) and/or load beam to which the flexure is coupled, and an actuator (e.g., the VCM) to which the actuator arm is coupled, may be collectively referred to as a head stack assembly (HSA). An HSA may, however, include more or fewer components than those described. For example, an HSA may refer to an assembly that further includes electrical interconnection components. Generally, an HSA is the assembly configured to move the head slider to access portions of the medium 120 for read and write operations.

With further reference to FIG. 1, electrical signals (e.g., current to the voice coil 140 of the VCM) comprising a write signal to and a read signal from the head 110a, are provided by a flexible interconnect cable 156 (“flex cable”). Interconnection between the flex cable 156 and the head 110a may be provided by an arm-electronics (AE) module 160, which may have an on-board pre-amplifier for the read signal, as well as other read-channel and write-channel electronic components. The AE module 160 may be attached to the carriage 134 as shown. The flex cable 156 is coupled to an electrical-connector block 164, which provides electrical communication through electrical feedthroughs provided by an HDD housing 168. The HDD housing 168, also referred to as a base, in conjunction with an HDD cover provides a sealed, protective enclosure for the information storage components of the HDD 100.

Other electronic components, including a disk controller and servo electronics including a digital-signal processor (DSP), provide electrical signals to the drive motor, the voice coil 140 of the VCM and the head 110a of the HGA 110. The electrical signal provided to the drive motor enables the drive motor to spin providing a torque to the spindle 124 which is in turn transmitted to the medium 120 that is affixed to the spindle 124. As a result, the medium 120 spins in a direction 172. The spinning medium 120 creates a cushion of air that acts as an air-bearing on which the air-bearing surface (ABS) of the slider 110b rides so that the slider 110b flies above the surface of the medium 120 without making contact with a thin magnetic-recording layer in which information is recorded. Similarly in an HDD in which a lighter-than-air gas is utilized, such as helium for a non-limiting example, the spinning medium 120 creates a cushion of gas that acts as a gas or fluid bearing on which the slider 110b rides.

The electrical signal provided to the voice coil 140 of the VCM enables the head 110a of the HGA 110 to access a track 176 on which information is recorded. Thus, the armature 136 of the VCM swings through an arc 180, which enables the head 110a of the HGA 110 to access various tracks on the medium 120. Information is stored on the medium 120 in a plurality of radially nested tracks arranged in sectors on the medium 120, such as sector 184. Correspondingly, each track is composed of a plurality of sectored track portions (or “track sector”), for example, sectored track portion 188. Each sectored track portion 188 may be composed of recorded data and a header containing a servo-burst-signal pattern, for example, an ABCD-servo-burst-signal pattern, which is information that identifies the track 176, and error correction code information. In accessing the track 176, the read element of the head 110a of the HGA 110 reads the servo-burst-signal pattern which provides a position-error-signal (PES) to the servo electronics, which controls the electrical signal provided to the voice coil 140 of the VCM, enabling the head 110a to follow the track 176. Upon finding the track 176 and identifying a particular sectored track portion 188, the head 110a either reads data from the track 176 or writes data to the track 176 depending on instructions received by the disk controller from an external agent, for example, a microprocessor of a computer system.

An HDD's electronic architecture comprises numerous electronic components for performing their respective functions for operation of an HDD, such as a hard disk controller (“HDC”), an interface controller, an arm electronics module, a data channel, a motor driver, a servo processor, buffer memory, etc. Two or more of such components may be combined on a single integrated circuit board referred to as a “system on a chip” (“SOC”). Several, if not all, of such electronic components are typically arranged on a printed circuit board that is coupled to the bottom side of an HDD, such as to HDD housing 168.

References herein to a hard disk drive, such as HDD 100 illustrated and described in reference to FIG. 1, may encompass a data storage device that is at times referred to as a “hybrid drive”. A hybrid drive refers generally to a storage device having functionality of both a traditional HDD (see, e.g., HDD 100) combined with solid-state storage device (SSD) using non-volatile memory, such as flash or other solid-state (e.g., integrated circuits) memory, which is electrically erasable and programmable. As operation, management and control of the different types of storage media typically differs, the solid-state portion of a hybrid drive may include its own corresponding controller functionality, which may be integrated into a single controller along with the HDD functionality. A hybrid drive may be architected and configured to operate and to utilize the solid-state portion in a number of ways, such as, for non-limiting examples, by using the solid-state memory as cache memory, for storing frequently-accessed data, for storing I/O intensive data, and the like. Further, a hybrid drive may be architected and configured essentially as two storage devices in a single enclosure, i.e., a traditional HDD and an SSD, with either one or multiple interfaces for host connection.

### Introduction

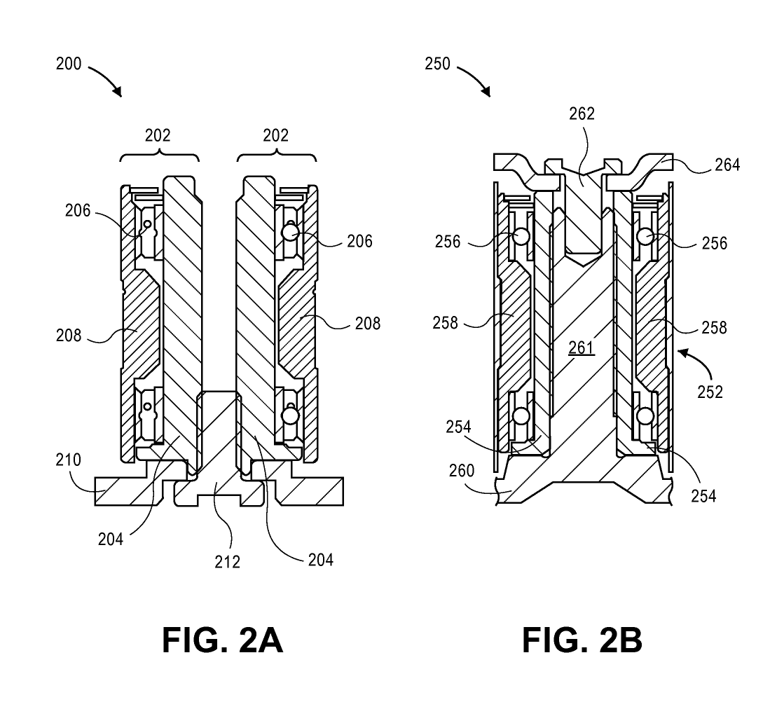

FIG. 2A is a cross-sectional side view illustrating a pivot bearing assembly coupled to a base with an attachment device. In the context of an HDD, a pivot bearing assembly such as pivot bearing assembly 200 is typically disposed within a carriage bore of an actuator comb, e.g., an actuator comb of a voice coil actuator. Pivot bearing assembly 200 comprises a bearing assembly 202 having a shaft 204, a bearing 206 (e.g., a set of ball bearings), and a bearing sleeve 208. Bearing assembly 202 is attached to an HDD enclosure base 210 by an attachment device 212, such as a screw. FIG. 2A represents a common installation approach for non-sealed HDDs. However, as mentioned, in the context of a sealed HDD it is not best practice to attach the bottom screw of the actuator pivot through the base because of leakage concerns. For example, use of attachment device 212 to attach bearing assembly 202 to the enclosure base 210 through a hole in the base 210 is not ideal in a sealed HDD because of the potential leakage path introduced by use of the attachment hole.

Therefore, one approach to installing a pivot bearing assembly into a sealed HDD is to utilize a base tower structure (or simply “tower”) integral to the HDD enclosure base, to which the pivot bearing assembly is attached. FIG. 2B is a cross-sectional side view illustrating a pivot bearing assembly coupled to a base tower. In the context of an HDD, a pivot bearing assembly such as pivot bearing assembly 250 is typically disposed within a carriage bore of an actuator comb, e.g., an actuator comb of a voice coil actuator. Pivot bearing assembly 250 comprises a bearing assembly 252 having a shaft 254, a bearing 256 (e.g., a set of ball bearings), and a bearing sleeve 258. Bearing assembly 252 is attached to an HDD enclosure base 260 by disposing the bearing assembly 252 onto a base tower 261, and attaching the bearing assembly 252 to the base tower 261 utilizing an attachment device 262 through an HDD inner cover 264. FIG. 2B represents one example installation approach for sealed HDDs. Note that the inner cover 264 is typically enveloped within a sealed outer cover and, thus, the leakage concern associated with the hole through the cover 264 is not consistent with the leakage concern associated with the hole through the base 210 of FIG. 2A.

With a pivot bearing such as pivot bearing 252 installed into an HDD using a tower structure such as base tower 261, some clearance between the inner diameter of the pivot shaft 254 and the base tower 261 is preferred, to facilitate ease of manufacturing for example. However, such clearance may provide for potential tilting of the pivot bearing 252, and thus the actuator assembly of which the pivot bearing 252 is a part, relative to the tower 261. Furthermore, such tilt may be undesirable in the context of subsequent assembly processes.

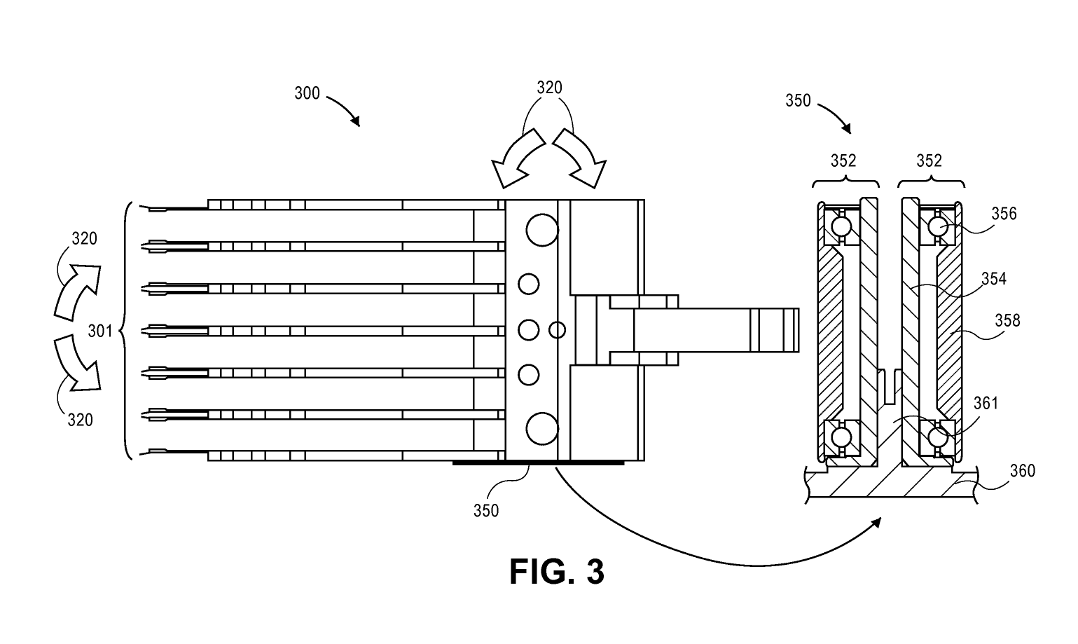

FIG. 3 is a side view illustrating an actuator assembly and a corresponding cross-sectional side view of a pivot bearing assembly coupled to a base tower. FIG. 3 depicts a “high-density” actuator assembly 300 comprising a relatively large actuator comb comprising a relatively large number of actuator arms 301 on a single carriage. Because the amount of potential tilt (represented by block arrows 320) depends on the amount of clearance between the pivot bearing and the tower, with a high-density actuator assembly such as actuator assembly 300 the degree of tilt that may occur at the top of the actuator may be significant. For example, with reference to pivot bearing assembly 350, which comprises a bearing assembly 352 having a shaft 354, a bearing 356, and a bearing sleeve 358 coupled to an HDD enclosure base 360 by disposing the bearing assembly 352 onto a base tower 361, the large distance between the top of the tower 361 and the top of the bearing assembly 352 in conjunction with any clearance between the shaft 354 and the tower 361 provides a significant lever for tilting of the actuator assembly 300 relative to the tower 361 (e.g., with comparison to pivot bearing assembly 250 of FIG. 2B), with maximum displacement towards the top of the actuator assembly 300.

### Clearance Spacer Mechanism for Actuator Pivot-Base Tower Assembly

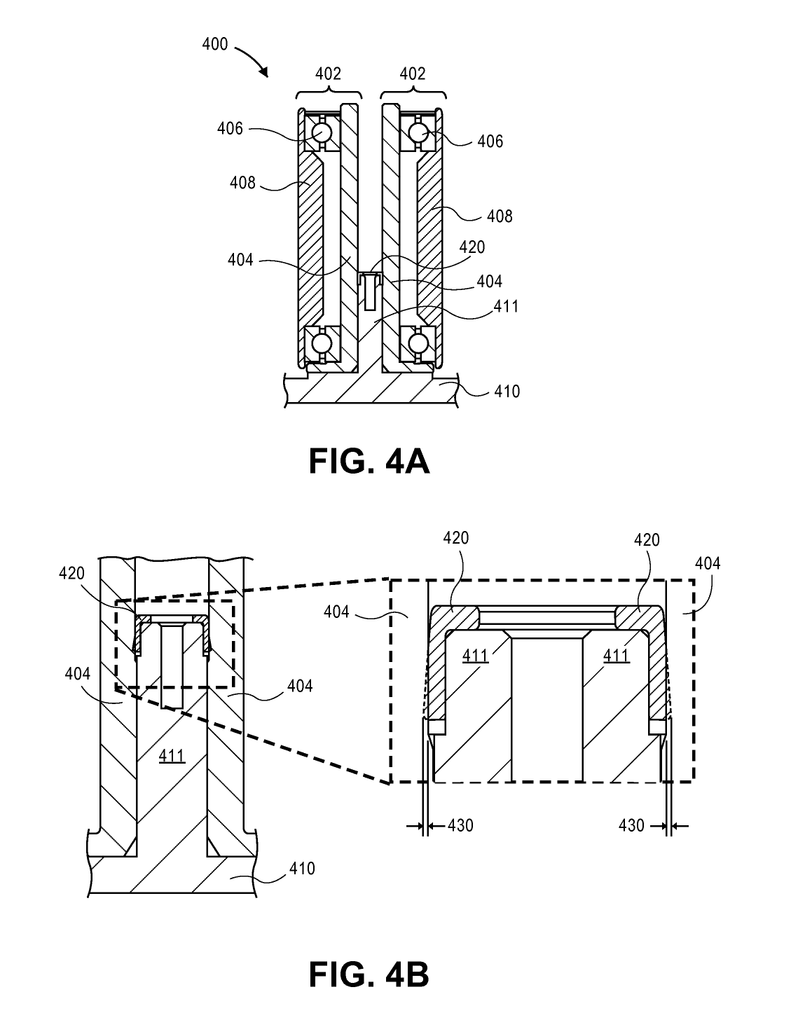

FIG. 4A is a cross-sectional side view illustrating a pivot bearing assembly coupled to a base tower structure including a clearance spacer mechanism, according to an embodiment. Pivot bearing assembly 400 which comprises a bearing assembly 402 having a shaft 404, a bearing 406, and a bearing sleeve 408 coupled to an HDD enclosure base 410 by disposition of the bearing assembly 402 onto a base tower 411. Pivot bearing assembly 400 further comprises a clearance spacer mechanism 420. Somewhat similar in construction to the pivot bearing assembly 350 of FIG. 3, there is a relatively large distance between the top of the tower 411 and the top of the bearing assembly 402, such as what may be present with a high-density actuator assembly in a sealed HDD context, for a non-limiting example. Hence, but for the use of the clearance spacer mechanism 420, excessive clearance between the shaft 404 and the tower 411 could allow for the tilting of a corresponding actuator assembly, such as like the actuator assembly 300 of FIG. 3.

FIG. 4B is a cross-sectional side view illustrating the pivot bearing assembly of FIG. 4A, along with a corresponding magnified view, according to an embodiment. Depicted in FIG. 4B is the tower 411 of base 410 which, according to an embodiment, are both formed together in a unitary construction such as a die casting. Tower 411 is depicted with the bearing assembly 402 (partially shown) disposed thereon, whereby the inner diameter of the shaft 404 of the bearing assembly 402 mates with the outer diameter of the tower 411, with the clearance spacer mechanism disposed at least in part therebetween. According to an embodiment, the clearance spacer mechanism 420 is positioned to reduce the clearance space between the shaft 404 and the tower 411, which likewise reduces the clearance space between the voice coil actuator, of which the bearing assembly 402 is part, and the tower 411. According to a related embodiment, the clearance spacer mechanism 420 is positioned to limit the potential and/or real tilting of an actuator comb, which has the likewise effect of limiting the tilting of the voice coil actuator of which the actuator comb and the bearing assembly 402 are part, relative to the tower 411.

### Elastic Cap

According to an embodiment, the clearance spacer mechanism 420 comprises an elastic cap positioned over the top of the tower 411, similar to as depicted in FIGS. 4A, 4B. According to a related embodiment, the elastic cap clearance spacer mechanism 420 is structurally configured with an outer diameter that is greater than the inner diameter of the shaft 404 of the bearing assembly 402, such that at least a portion of the elastic cap clearance spacer mechanism 420 is compressed while positioned between the tower 411 and the shaft 404. According to an embodiment, one approach to the foregoing structural configuration of the elastic cap clearance spacer mechanism 420 is to form the elastic cap clearance spacer mechanism 420 as a conical shape, e.g., whereby the outer diameter of the elastic cap clearance spacer mechanism 420 increases from the top towards the bottom of the cap, with the corresponding inner diameter of the cap either increasing similarly or remaining relatively constant (i.e., the cap wall material thickness increasing from top to bottom).

With reference to the magnified view of FIG. 4B, the foregoing compression of the sides of the elastic cap clearance spacer mechanism 420 is represented by the compression amount 430. Hence, the clearance space between the tower 411 and the shaft 404 of bearing assembly 402 is reduced and a tighter fit of the pivot bearing assembly 400 with the tower 411 is therefore provided, thereby, for example, reducing the potential for or the actual tilt. Consequently, the accuracy of subsequent assembly processes may be realized. Furthermore, use of an elastic cap clearance spacer mechanism 420 may reduce the effects of an HDD shock event on a corresponding actuator assembly, such as like the actuator assembly 300 of FIG. 3.

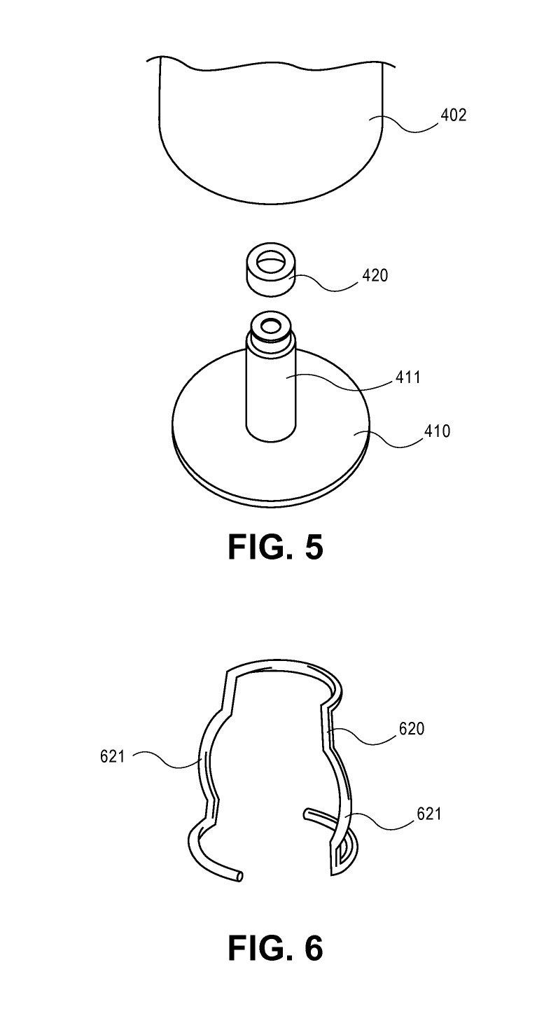

FIG. 5 is an exploded perspective view illustrating a pivot bearing-base tower assembly including a clearance spacer mechanism, according to an embodiment. The exploded view of FIG. 5 depicts the base tower 411 as an integral, unitary part with the base 410 (simplified), the elastic cap clearance spacer mechanism 420 for positioning over the top of the tower 411, and the bearing assembly 402 (simplified) for positioning over/on the elastic cap 420-tower 411 assembly. A conically-shaped elastic cap clearance spacer mechanism 420 may further provide for a simpler, more reliable bearing assembly 402 installation process.

### Spring Mechanism

FIG. 6 is a perspective view of a clearance spacer mechanism, according to an embodiment. According to an embodiment, an alternative clearance spacer mechanism may take the form of a spring mechanism configured for positioning over the top of the tower 411. FIG. 6 depicts such a spring mechanism 620 as one non-limiting approach to a spring clearance spacer mechanism. For a non-limiting example, the spring mechanism 620 may be formed from a thin metal such as a stiff metal wire.

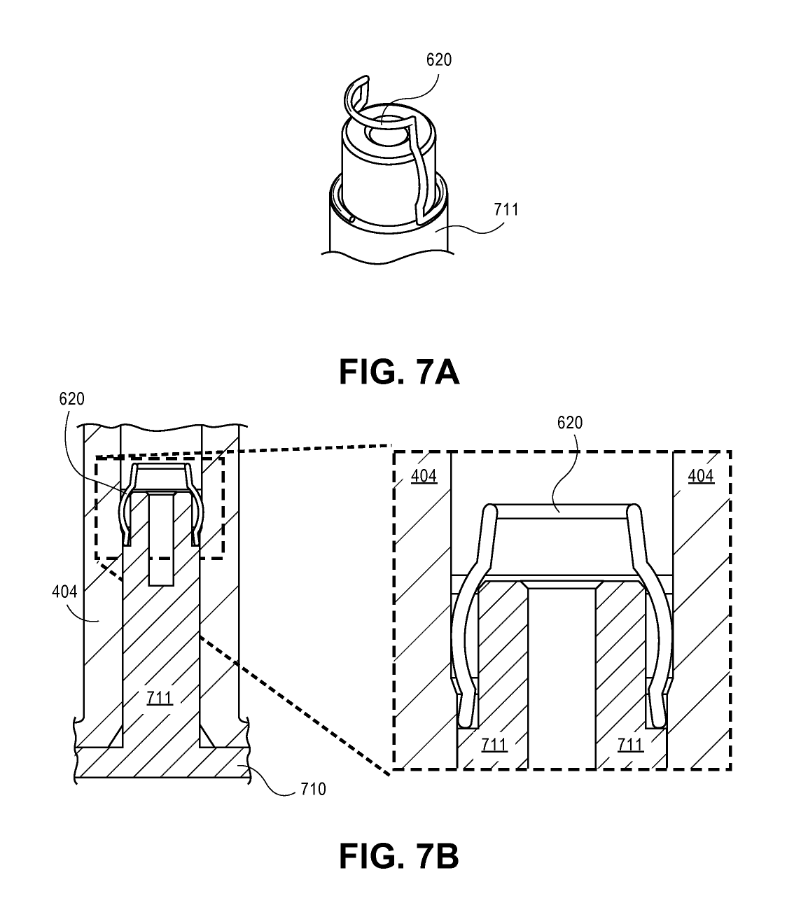

FIG. 7A is a cross-sectional side view illustrating the clearance spacer mechanism of FIG. 6 coupled to a base tower, according to an embodiment. That is, FIG. 7A depicts the spring mechanism 620 positioned over the top of and coupled to a base tower 711.

FIG. 7B is a cross-sectional side view illustrating a pivot bearing assembly coupled to a base tower structure including a clearance spacer mechanism, along with a corresponding magnified view, according to an embodiment. Depicted in FIG. 7B is the tower 711 of base 710 which, according to an embodiment, are both formed together in a unitary construction such as a die casting. Tower 711 is depicted with the bearing assembly 402 (partially shown) disposed thereon, whereby the inner diameter of the shaft 404 of the bearing assembly 402 mates with the outer diameter of the tower 711, with the spring mechanism 620 disposed at least in part therebetween. According to an embodiment, the spring mechanism 620 is positioned to reduce the clearance space between the shaft 404 and the tower 711, which likewise reduces the clearance space between the voice coil actuator, of which the bearing assembly 402 is part, and the tower 711. According to a related embodiment, the spring mechanism 620 is positioned to limit the potential and/or real tilting of an actuator comb, which likewise limits the tilting of the voice coil actuator of which the actuator comb and the bearing assembly 402 are part, relative to the tower 711.

According to an embodiment, the spring clearance spacer mechanism, i.e., spring mechanism 620, is structurally configured with an outermost portion 621 (FIG. 6) that is greater than the inner diameter of the shaft 404 of the bearing assembly 402, such that at least a portion of the spring mechanism 620 is compressed while positioned between the tower 711 and the shaft 404. The example depicted in FIG. 7B illustrates the spring mechanism 620 in a compressed state within the inner walls of the shaft 404. Hence, the clearance space between the tower 711 and the shaft 404 of bearing assembly 402 is reduced and a tighter fit of the pivot bearing assembly 400 (partially shown) with the tower 711 is therefore provided, thereby, for example, reducing the potential for or the actual tilt. Consequently, the accuracy of subsequent assembly processes may be realized. Furthermore, use of a spring mechanism 620 as a clearance spacer mechanism may reduce the effects of an HDD shock event on a corresponding actuator assembly, such as like the actuator assembly 300 of FIG. 3.

### Process for Assembling an HDD Actuator Pivot Assembly

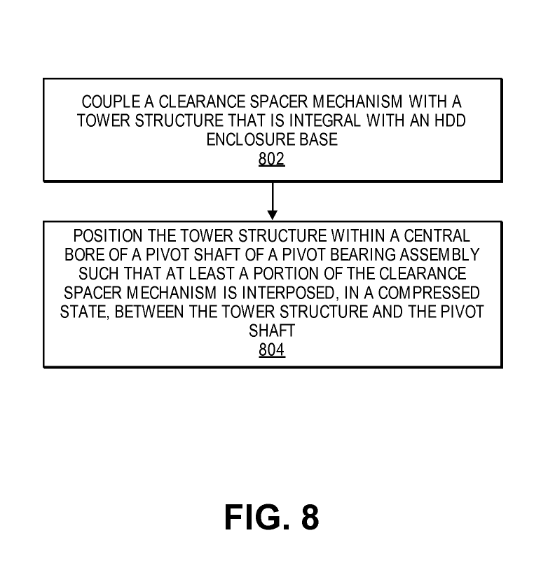

FIG. 8 is a flow diagram illustrating a method for assembling a hard disk drive (HDD) actuator pivot assembly, according to an embodiment. Such an actuator pivot assembly comprises a rotatable actuator comb comprising a carriage having a bore therethrough for disposing a pivot bearing assembly therein, where the pivot bearing assembly comprises a pivot shaft having a central bore (see, e.g., FIG. 1 and FIG. 3).

At block 802, a clearance spacer mechanism is coupled with a tower structure that is integral with an HDD enclosure base. For example, clearance spacer mechanism 420 is positioned over the top of tower 411 of enclosure base 410 (FIGS. 4A, 4B, 5). For another example, spring mechanism 620 is positioned over the top of tower 711 of enclosure base 710 (FIGS. 6, 7A, 7B).

At block 804, the tower structure is positioned within the central bore of the pivot shaft of the pivot bearing assembly such that at least a portion of the clearance spacer mechanism is interposed, in a compressed state, between the tower structure and the pivot shaft. For example, tower 411 may be positioned within pivot shaft 404 of pivot bearing assembly 402, such that a portion of clearance spacer mechanism 420 is interposed in a compressed state between the tower 411 and the pivot shaft 404 (FIGS. 4A, 4B, 5). Stated otherwise, the pivot shaft 404 of pivot bearing assembly 402 may be positioned on or around the tower 411, thereby compressing a portion of the clearance spacer mechanism 420, such as the elastic cap clearance spacer mechanism (see, e.g., magnified window of FIG. 4B). For another example, tower 711 may be positioned within pivot shaft 404 of pivot bearing assembly 402, such that a portion of spring mechanism 620 is interposed, in a compressed state, between the tower 711 and the pivot shaft 404 (FIGS. 6, 7A, 7B). Stated otherwise, the pivot shaft 404 of pivot bearing assembly 402 is positioned over or around the tower 711, thereby compressing a portion of the spring mechanism 620 (see, e.g., magnified window of FIG. 7B).

As discussed, positioning the tower 411, 711 within the pivot bearing assembly 402 includes positioning the clearance spacer mechanism 420, 620 such that the clearance between the tower 411, 711 and the pivot shaft 404 is reduced, to limit the potential of the actuator comb to tilt relative to the tower 411, 711.

### Extensions and Alternatives

In the foregoing description, embodiments of the invention have been described with reference to numerous specific details that may vary from implementation to implementation. Therefore, various modifications and changes may be made thereto without departing from the broader spirit and scope of the embodiments. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

In addition, in this description certain process steps may be set forth in a particular order, and alphabetic and alphanumeric labels may be used to identify certain steps. Unless specifically stated in the description, embodiments are not necessarily limited to any particular order of carrying out such steps. In particular, the labels are used merely for convenient identification of steps, and are not intended to specify or require a particular order of carrying out such steps.

1. A hard disk drive comprising:
a recording disk medium rotatably mounted on a spindle;
a head slider comprising a read-write transducer configured to read from and to write to said disk medium;
a voice coil actuator configured to move said head slider to access portions of said disk medium, said actuator comprising a pivot assembly comprising:
a rotatable actuator comb comprising a carriage having a bore therethrough, and
a pivot bearing assembly disposed in said carriage bore and comprising a pivot shaft having a central bore;
an enclosure base comprising a tower structure on which said pivot shaft is disposed; and
a clearance spacer mechanism positioned over the top of said tower structure and radially between said tower structure and said pivot shaft and configured to affect the radial clearance between said voice coil actuator and said tower structure.

2. The hard disk drive of claim 1, wherein said clearance spacer mechanism is positioned to reduce said radial clearance between said voice coil actuator and said tower structure.

3. The hard disk drive of claim 2, wherein said clearance spacer mechanism is positioned to limit tilting of said actuator comb relative to said tower structure.

4. The hard disk drive of claim 1, wherein said clearance spacer mechanism comprises an elastic cap.

5. The hard disk drive of claim 4, wherein the outer diameter of said elastic cap is greater than the inner diameter of said pivot shaft such that at least a portion of said elastic cap is compressed while positioned between said tower structure and said pivot shaft.

6. The hard disk drive of claim 4, wherein said elastic cap is conically-shaped.

7. The hard disk drive of claim 1, wherein said clearance spacer mechanism comprises a spring mechanism positioned over the top of said tower structure.

8. The hard disk drive of claim 7, wherein the diameter of an outermost portion of said spring mechanism is greater than the inner diameter of said pivot shaft such that said outermost portion of said spring mechanism is compressed while positioned between said tower structure and said pivot shaft.

9. The hard disk drive of claim 1, wherein said enclosure base and said tower structure are constructed together as a unitary part.

10. A clearance spacer mechanism configured for positioning radially between an enclosure base tower structure and a voice coil actuator pivot shaft of a hard disk drive, said clearance spacer mechanism comprising:
an elastic cap having a wall portion extending from a top portion, thereby structurally configured to fit over the top of a base tower structure to reduce the radial clearance between said base tower structure and an actuator pivot shaft.

11. The clearance spacer mechanism of claim 10, wherein the outer diameter of said elastic cap is greater than the inner diameter of said actuator pivot shaft such that at least a portion of said elastic cap is radially compressed while positioned radially between said base tower structure and said actuator pivot shaft.

12. The clearance spacer mechanism of claim 10, wherein said elastic cap is conically-shaped.

13. A clearance spacer mechanism configured for positioning radially between an enclosure base tower structure and a voice coil actuator pivot shaft of a hard disk drive, said clearance spacer mechanism comprising:
a spring mechanism configured to fit over the top of said base tower structure to reduce the radial clearance between said base tower structure and said actuator pivot shaft.

14. The clearance spacer mechanism of claim 13, wherein the diameter of an outermost portion of said spring mechanism is greater than the inner diameter of said actuator pivot shaft such that said outermost portion of said spring mechanism is compressed while positioned between said base tower structure and said actuator pivot shaft.

15. A method for assembling a hard disk drive (HDD) actuator pivot assembly comprising a rotatable actuator comb comprising a carriage having a bore therethrough for disposing a pivot bearing assembly therein, said pivot bearing assembly comprising a pivot shaft having a central bore, the method comprising:
coupling a clearance spacer mechanism over the top of a tower structure that is integral with an HDD enclosure base; and
positioning said tower structure within said central bore of said pivot shaft such that at least a portion of said clearance spacer mechanism is radially interposed, in a compressed state, between said tower structure and said pivot shaft.

16. The method of claim 15, wherein positioning said tower structure includes positioning said clearance spacer mechanism such that the radial clearance between said tower structure and said pivot shaft is reduced to limit the potential of said actuator comb to tilt relative to said tower structure.

17. The method of claim 15, wherein coupling said clearance spacer mechanism includes positioning a clearance spacer mechanism comprising an elastic cap over the top of said tower structure.

18. The method of claim 15, wherein coupling said clearance spacer mechanism includes positioning a clearance spacer mechanism comprising a spring mechanism over the top of said tower.
